(19) United States
(12) Patent Application Publication
(10) Pub. No.: US 2026/0288343 A1
(43) Pub. Date: Sep. 24, 2026

(54) MEMORY SYSTEM

(71) Applicant: Kioxia Corporation, Tokyo (JP)

(72) Inventor: Yasuyuki UEDA, Kawasaki (JP)

(73) Assignee: Kioxia Corporation, Tokyo (JP)

(21) Appl. No.: 19/324,888

(22) Filed: Sep. 10, 2025

(30) Foreign Application Priority Data
Mar. 18, 2025 (JP) 2025-043749

(51) Int. Cl. G06F 3/06

(52) U.S. Cl. CPC G06F 3/0614; G06F 3/0634; G06F 3/0659; G06F 3/0679

(57) ABSTRACT

A memory system includes a nonvolatile memory perform writing in either a first mode or a second mode; and a memory controller configured to: write first data to the nonvolatile memory in the second mode until a condition related to any one of a first value, a second value, or a third value is satisfied, the first value being a total value of time during which a power-on state is maintained, the second value being the number of times a power has been turned on, and the third value being the number of program/erase cycles executed on the nonvolatile memory; and after the condition is satisfied, write second data to the nonvolatile memory in the first mode.

### CROSS-REFERENCE TO RELATED APPLICATION

This application is based upon and claims the benefit of priority from Japanese Patent Application No. 2025-043749, filed Mar. 18, 2025, the entire contents of which are incorporated herein by reference.

### FIELD

Embodiments described herein relate generally to a memory system.

### BACKGROUND

Memory systems equipped with nonvolatile memories having memory cell transistors are widely used. For example, when a memory system or an information processing system having the memory system is shipped and then stored for a long time in an undesirable environment without powering on the memory system, an error may occur in the data stored in the nonvolatile memory.

### DESCRIPTION OF THE DRAWINGS

FIG. 1 is a diagram showing an example of a configuration of a memory system according to a first embodiment.

FIG. 2 is a diagram showing an example of a configuration of memory chips according to the first embodiment.

FIG. 3 is a diagram showing an example of a circuit configuration of a block according to the first embodiment.

FIG. 4 is a diagram illustrating the sections in each of the cases of an SLC mode, an MLC mode, a TLC mode, and a QLC mode, in the first embodiment.

FIG. 5 is a diagram showing an example of data stored in a NAND memory according to the first embodiment.

FIG. 6 is a diagram showing an example of an operation of an information processing system according to the first embodiment.

FIG. 7 is a flowchart showing an example of a mode switching determination operation according to the first embodiment.

FIGS. 8A, 8B, and 8C are each a diagram illustrating an example of the transition of the state of user data stored in the NAND memory according to the first embodiment.

FIG. 9 is a diagram showing an example of data stored in a NAND memory according to a second embodiment.

FIG. 10 is a diagram illustrating a specific example of information recorded in time/POH information according to the second embodiment.

FIG. 11 is a diagram illustrating a method of calculating an elapsed time since data was last written according to the second embodiment.

FIG. 12 is a diagram showing an example of an operation of an information processing system according to the second embodiment.

FIG. 13 is a flowchart showing an example of a refresh execution determination operation according to the second embodiment.

FIG. 14 is a diagram showing an example of a configuration of a memory system according to a third embodiment.

FIG. 15 is a diagram showing an example of an operation of an information processing system according to the third embodiment.

FIG. 16 is a flowchart showing an example of a refresh execution determination operation according to the third embodiment.

### DETAILED DESCRIPTION

Embodiments provide a memory system having high reliability.

In general, according to one embodiment, a memory system is connectable to a host. The memory system includes a nonvolatile memory configured to perform writing in either a first mode or a second mode; and a memory controller configured to: write first data, received from the host, to the nonvolatile memory in the second mode until a condition related to any one of a first value, a second value, or a third value is satisfied, the first value being a total value of time during which a power-on state is maintained, the second value being the number of times a power has been turned on, and the third value being the number of program/erase cycles executed on the nonvolatile memory; and after the condition is satisfied, write second data, received from the host, to the nonvolatile memory in the first mode.

A memory system according to embodiments will be described in detail below with reference to the accompanying drawings. The present disclosure is not limited to these embodiments.

### First Embodiment

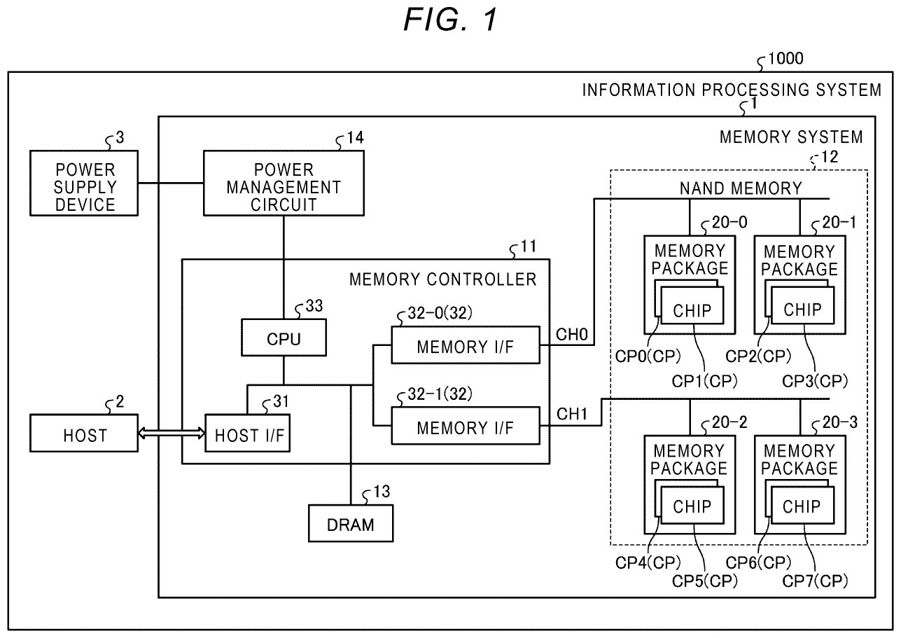

FIG. 1 is a diagram showing an example of the configuration of a memory system according to a first embodiment. As shown in FIG. 1, a memory system 1 is incorporated into an information processing system 1000. The information processing system 1000 is a computer system such as a personal computer or a server.

The information processing system 1000 includes the memory system 1, a host 2 for the memory system 1, and a power supply device 3. The host 2 is a processor that provides overall control of the information processing system 1000. The power supply device 3 supplies power to the memory system 1.

The memory system 1 is connected to the host 2 via a predetermined communication interface. The memory system 1 can receive various requests from the host 2. The various requests include write requests and read requests.

The memory system 1 includes a memory controller 11, a NAND flash memory (NAND memory) 12, a Dynamic Random Access Memory (DRAM) 13, and a power management circuit 14.

The NAND memory 12 is a nonvolatile memory that functions as a storage. The NAND memory 12 includes one or more memory chips CP. Here, eight memory chips CP0 to CP7 are illustrated as an example of the one or more memory chips CP. A plurality of memory chips CP may be configured as a single package sealed with resin or the like. As an example, a memory package 20-0 including the memory chips CP0 and CP1, a memory package 20-1 including the memory chips CP2 and CP3, a memory package 20-2 including the memory chips CP4 and CP5, and a memory package 20-3 including the memory chips CP6 and CP7 are shown here.

The memory controller 11 and the NAND memory 12 are connected via one or more channels. As an example, the memory system 1 has two channels CH0 and CH1. The two channels CH0 and CH1 are connected to the memory controller 11. The memory packages 20-0 and 20-1 are connected to the channel CH0, and the memory packages 20-2 and 20-3 are connected to the channel CH1.

The number of channels, the number of memory chips CP, the number of memory packages 20, and a wiring between the memory controller 11 and each of the memory chips CP provided in the memory system 1 are not limited to this example.

The memory controller 11 executes various processes including data transfer between the host 2 and the NAND memory 12. To achieve this, the memory controller 11 includes a host Interface (I/F) 31, one or more memory I/Fs 32, and a Central Processing Unit (CPU) 33.

The host I/F 31 controls the transfer of information such as requests and data with the host 2.

The CPU 33 implements overall control of the memory controller 11 based on a firmware program.

Based on instructions from the CPU 33, the memory I/F 32 transfers commands for performing access to the NAND memory 12 via a channel to the target memory chips CP, or transfers data corresponding to the commands to the NAND memory 12. Access to the NAND memory 12 includes writing data, reading data, and erasing data.

In the example shown in FIG. 1, the memory controller 11 has two memory I/Fs 32-0 and 32-1 as an example of one or more memory I/Fs 32. The memory I/F 32-0 controls the transfer of commands and data via the channel CH0, and the memory I/F 32-1 controls the transfer of commands and data via the channel CH1. The number of memory I/Fs 32 provided in the memory controller 11 is not limited to two.

The DRAM 13 provides an area as a buffer or cache to the memory controller 11. For example, the memory controller 11 can use the DRAM 13 as a buffer for data transferred between the host 2 and the NAND memory 12, or as an area for temporarily storing various types of management information. The memory that provides an area as a buffer or cache is not limited to a DRAM. The memory that provides an area as a buffer or cache may be a DRAM, a Static Random Access Memory (SRAM), other memories, or a combination of some or all of these.

The power management circuit 14 generates power for driving the memory controller 11, the NAND memory 12, and the DRAM 13, based on the power input from the power supply device 3. The power management circuit 14 then supplies the generated power to them. When the power supply from the power supply device 3 starts under the control of the host 2, the power management circuit 14 notifies the CPU 33 that the power is turned on. When the power supply from the power supply device 3 is cut off, the power management circuit 14 notifies the CPU 33 that the power is turned off. When the power is turned off, the host 2 may notify the memory system 1 of a power-off notice.

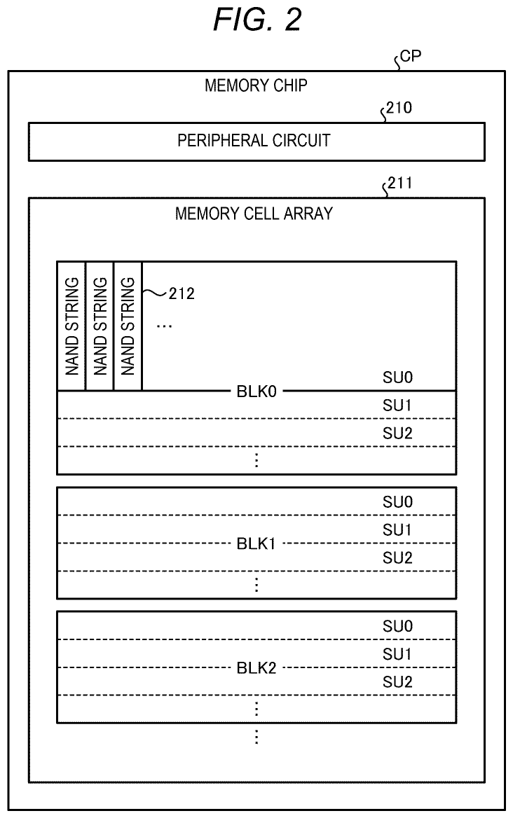

FIG. 2 is a diagram showing an example of a configuration of the memory chips CP according to the first embodiment. The memory chips CP each include a peripheral circuit 210 and a memory cell array 211.

The memory cell array 211 includes a plurality of blocks BLK (BLK0, BLK1, BLK2, . . . ). Each block BLK includes a plurality of string units SU (SU0, SU1, SU2, . . . ). Each string unit SU includes a plurality of NAND strings 212. Each NAND string 212 includes a plurality of nonvolatile memory cell transistors connected in series. The string unit SU has any number of NAND strings 212. The NAND string 212 has any number of memory cell transistors.

The peripheral circuit 210 includes, for example, a row decoder, a column decoder, a sense amplifier, a latch circuit, and a voltage generation circuit. In response to a command from the memory controller 11, the peripheral circuit 210 executes an operation corresponding to the command on the memory cell array 211. For example, in response to a command, the peripheral circuit 210 executes operations such as writing data to the memory cell array 211, reading data from the memory cell array 211, or erasing data stored in the memory cell array 211.

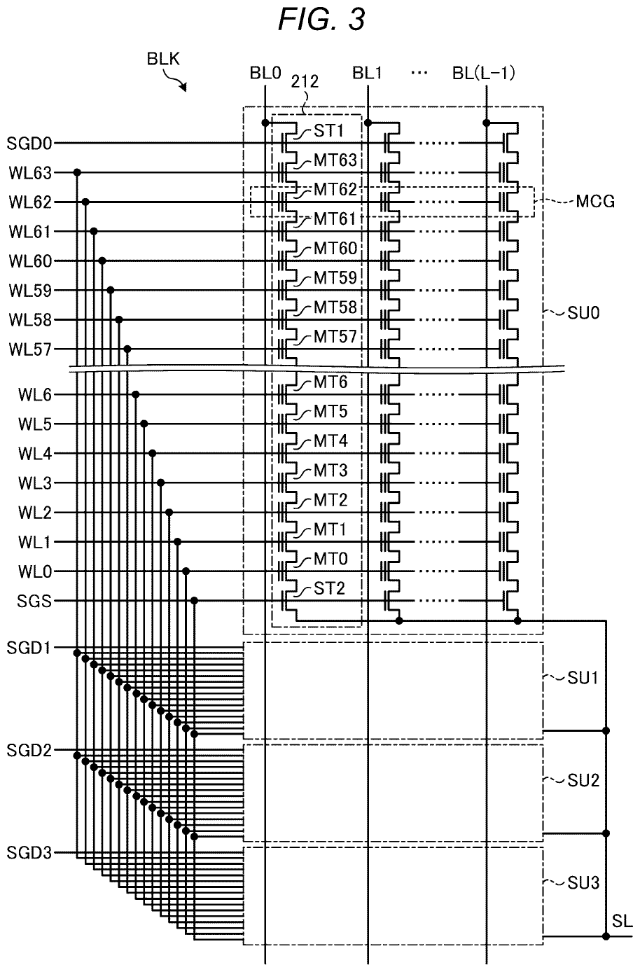

FIG. 3 is a diagram showing an example of a circuit configuration of the block BLK in the first embodiment. Each block BLK has the same configuration. The block BLK has, for example, four string units SU0 to SU3. Each string unit SU includes a plurality of NAND strings 212.

Each of the NAND strings 212 includes, for example, 64 memory cell transistors MT (MT0 to MT63) and select transistors ST1 and ST2. The memory cell transistor MT has a control gate and a charge storage layer, and stores data in a non-volatile manner. The 64 memory cell transistors MT (MT0 to MT63) are connected in series between the source of the select transistor ST1 and the drain of the select transistor ST2. The memory cell transistor MT may be of a Metal-Oxide-Nitride-Oxide-Silicon (MONOS) type that uses an insulating film for the charge storage layer, or of a Floating Gate (FG) type that uses a conductive film for the charge storage layer. The number of memory cell transistors MT in the NAND string 212 is not limited to 64.

The gates of the select transistors ST1 in the string units SU0 to SU3 are connected to select gate lines SGD0 to SGD3, respectively. In contrast, the gates of the select transistors ST2 in the string units SU0 to SU3 are commonly connected to, for example, a select gate line SGS. The gates of the select transistors ST2 in the string units SU0 to SU3 may be connected to different select gate lines SGS0 to SGS3 (not shown), respectively, for respective string units SU. The control gates of the memory cell transistors MT0 to MT63 in the same block BLK are commonly connected to word lines WL0 to WL63, respectively.

The drains of the select transistors ST1 of respective NAND strings 212 in the string unit SU are connected to different bit lines BL (BL0 to BL(L−1), where L is a natural number equal to or greater than 2). The bit line BL also commonly connects one NAND string 212 in each string unit SU across a plurality of blocks BLK. Further, the sources of the respective select transistors ST2 are also commonly connected to a source line SL.

In other words, a string unit SU is a collection of a plurality of NAND strings 212 each connected to a different bit line BL and connected to the same select gate line SGD. A block BLK is also a collection of a plurality of string units SU that share a word line WL. The memory cell array 211 is also a collection of a plurality of blocks BLK that share at least one bit line BL.

Write operations and read operations by the peripheral circuit 210 can be executed collectively on the memory cell transistors MT connected to one word line WL in one string unit SU. A group of memory cell transistors MT selected collectively during write operations and read operations is referred to as a memory cell group MCG. The size of a collection of 1-bit data stored in each memory cell transistor MT in one memory cell group MCG is referred to as a page. The write operation by the peripheral circuit 210 is also referred to as a program. The read operation by the peripheral circuit 210 is also referred to as a sense.

The data erase operation by the peripheral circuit 210 is executed in block BLK units. In other words, all data stored in one block BLK is erased together.

The configuration of the memory cell array 211 is not limited to the configuration shown in FIGS. 2 and 3. For example, the memory cell array 211 may have a configuration in which the NAND strings 212 are arranged two-dimensionally or three-dimensionally.

Each memory cell transistor MT can store a value of n bits (n≥1). The mode in which n is 1 is called a Single-Level Cell (SLC) mode. When each memory cell transistor MT stores a value of n bits, the storage capacity per memory cell group MCG is equal to the size of n pages. The mode in which n is 2 is called a multi-level cell (MLC) mode. The mode in which n is 3 is called a triple-level cell (TLC) mode. The mode in which n is 4 is called a quad-level cell (QLC) mode.

The threshold voltage of each memory cell transistor MT is controlled within a certain range by the peripheral circuit 210. The controllable range of the threshold voltage is divided into sections of the n-th power of 2, and a different n-bit value is assigned to each section.

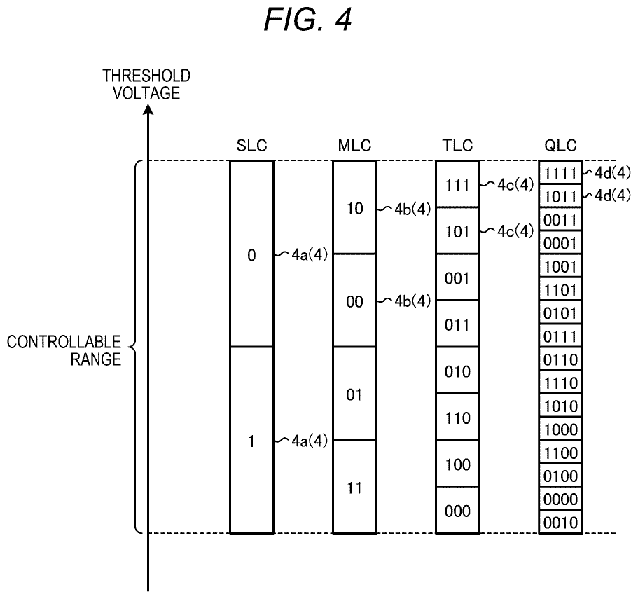

FIG. 4 is a diagram illustrating the sections in each of the cases of an SLC mode, an MLC mode, a TLC mode, and a QLC mode, in the first embodiment. As shown in FIG. 4, the threshold voltage range (controllable range) is divided into a plurality of sections 4.

For example, in the SLC mode, the threshold voltage range is divided into two sections 4a. In the MLC mode, the threshold voltage range is divided into four sections 4b. In the TLC mode, the threshold voltage range is divided into eight sections 4c. In the QLC mode, the threshold voltage range is divided into 16 sections 4d.

A value of the corresponding number of bits is assigned to each section 4. in the SLC mode, “0” is assigned to a section 4a on the high voltage side, and “1” is assigned to a section 4a on the low voltage side. In the MLC mode, “10”, “00”, “01”, and “11” are assigned to the four sections 4b in order from the high voltage side. In the TLC mode, “111”, “101”, “001”, “011”, “010”, “110”, “100”, and “000” are assigned to the eight sections 4c in order from the high voltage side. In the QLC mode, the following values “1111”, “1011”, “0011”, “0001”, “1001”, “1101”, “0101”, “0111”, “0110”, “1110”, “1010”, “1000”, “1100”, “0100”, “0000”, and “0010” are assigned to the 16 sections 4d in order from the high voltage side. The method of assigning a value to each section 4 is not limited to these examples.

In a write operation, the peripheral circuit 210 selects the bit line BL corresponding to the column address. The peripheral circuit 210 sets the voltage of the selected bit line BL to zero. The peripheral circuit 210 selects the word line WL corresponding to the row address and applies a programming pulse to the selected word line WL. Then, charges are injected into the charge storage layer of the memory cell transistor MT located at the intersection of the selected bit line BL and the selected word line WL, resulting in an increase in the threshold voltage of the memory cell transistor MT. The peripheral circuit 210 checks at a predetermined timing whether the threshold voltage reaches the target section 4 corresponding to the data. The peripheral circuit 210 continues applying the program pulse until the threshold voltage of the memory cell transistor MT reaches the target section 4.

In a read operation, the peripheral circuit 210 identifies the section 4 to which the threshold voltage of each memory cell transistor MT that configures the read destination memory cell group MCG belongs, and outputs the value assigned to the identified section 4 as read data.

In an erase operation, the peripheral circuit 210 applies an erase voltage to the substrate side of the memory cell array 211. Then, the peripheral circuit 210 electrically connects all word lines WL of the erase target block BLK to the ground voltage. Then, the charge stored in the charge storage layer of each memory cell transistor MT in the selected block BLK is discharged. As a result, the state of each memory cell transistor MT in the selected block BLK transitions to a state in which data is considered to be erased (i.e. section 4 on the lowest voltage side).

Each of memory chips CP is configured to be able to write data in either a first mode in which data having a first number of bits per memory cell transistor MT is stored, or a second mode in which data having a second number of bits (here, the second number is smaller than the first number) per memory cell transistor MT is stored.

The threshold voltage of the memory cell transistor MT changes due to various stresses. If the threshold voltage of a memory cell transistor MT belonging to a certain section 4 changes outside of that section 4, an error will occur in the data read from that memory cell transistor MT. Errors contained in the data read from the NAND memory 12 are corrected by an error correction circuit (not shown in FIG. 1). However, there is a limit to the error correction capability of the error correction circuit. Therefore, it is necessary to reduce the occurrence of errors as much as possible.

Data retention is known as one type of stress that affects the threshold voltage of a memory cell transistor MT. Data retention refers to the phenomenon in which the threshold voltage of a memory cell transistor MT changes over time after data is written to the memory cell transistor MT. The effects of data retention can also vary depending on the environmental temperature.

Here, a technology to be compared to the first embodiment will be described. The technology to be compared to the first embodiment will be referred to as a comparative example. According to the comparative example, the memory controller rewrites the data depending on an elapsed time since data was written. Such a rewrite is also called a refresh operation. The rewrite resets the effects of data retention that have stored in the data.

However, when the information processing system is not powered on for a long period of time, for example, from the time the information processing system is shipped to the time it is started to be used by an end user, who is a user of the information processing system, the memory controller cannot perform a refresh operation and the reliability of the data stored in the NAND memory may be compromised. In addition, the storage conditions after shipment may differ from case to case, and the effect of data retention may differ from case to case. For example, in cases of being stored in a high-temperature warehouse, the effect of data retention is large and the reliability of the data stored in the NAND memory is likely to be compromised.

In the first embodiment, in principle, the memory controller 11 writes the data received from the host 2 to the NAND memory 12 in the first mode to reduce bit cost. However, as is clear from FIG. 4, the more bits of a value stored in one memory cell transistor MT, the narrower the range of each section 4, and the more susceptible the data written to the memory cell transistor MT is to data retention. In other words, writing data in the second mode rather than the first mode provides higher tolerance to data retention and higher reliability. Therefore, in order to maintain high reliability of the data from the time the information processing system 1000 is shipped to the time it is started to be used by the end user, the memory controller 11 writes data in the second mode during the period from when the memory system 1 is started to be used until a certain condition is satisfied. Then, when the above conditions are satisfied, the memory controller 11 autonomously switches the storage mode from the second mode to the first mode.

The above conditions are set for determining whether use by an end user began. In the first embodiment, Power On Hours (POH), Power On Count (POC), and utilization rate are used as indices for determining whether use by an end user began.

POH is a total value of a time during which the memory system 1 is maintained in a power-on state. In other words, POH represents the cumulated usage time of the memory system 1. A POH threshold is set as a threshold to be compared with POH. The expected value of POH when use by an end user begins is determined as the POH threshold by the designer, who is the vendor of the memory system 1. The memory controller 11 monitors the POH in a power-on state. When the POH becomes greater than the POH threshold, the memory controller 11 switches the storage mode when writing to the NAND memory 12 from the second mode to the first mode.

POC is the number of times the memory system 1 was powered on. A POC threshold is set as a threshold to be compared with POC. The expected value of the POC when it is started to be used by the end user is determined as the POC threshold by the designer. The memory controller 11 increments the POC each time the memory system 1 is powered on. When the POC becomes greater than the POC threshold, the memory controller 11 switches the storage mode when writing to the NAND memory 12 from the second mode to the first mode.

The utilization rate is the ratio of the number of program/erase cycles executed to the upper limit of the number of program/erase cycles. The memory controller 11 repeatedly executes a cycle of writing (programming) data and erasing data, for each block BLK. This cycle is referred to as a program/erase cycle. The memory cell transistor MT becomes worn out depending on the number of program/erase cycles executed, and the reliability of the data stored in the memory cell transistor MT is likely to decrease. Therefore, an upper limit is set for the number of program/erase cycles. The utilization rate may be calculated using the number of program/erase cycles executed counted across the entire NAND memory 12, or the average value of the number of program/erase cycles executed across all memory chips CP.

The number of program/erase cycles executed increases according to the cumulative amount of data written to the NAND memory 12. Therefore, it can be considered that the utilization rate is correlated with the cumulative usage time of the memory system 1. Therefore, a utilization rate threshold is set as a threshold to be compared with the utilization rate. The expected value of the utilization rate when the memory system is started to be used by the end user is determined as the utilization rate threshold by the designer. The memory controller 11 monitors the utilization rate while the memory system 1 is in a power-on state. When the utilization rate becomes greater than the utilization rate threshold, the memory controller 11 switches the storage mode when writing to the NAND memory 12 from the second mode to the first mode.

Even when the memory controller 11 uses the number of program/erase cycles executed itself instead of the utilization rate as an index for determining whether use by the end user began, the memory controller 11 can make a determination substantially equivalent to that when the utilization rate is used.

In the following description, the first mode is the QLC mode, and the second mode is the SLC mode. The first and second modes are not limited to this example. Hereinafter, the memory cell transistor MT will be referred to as a memory cell.

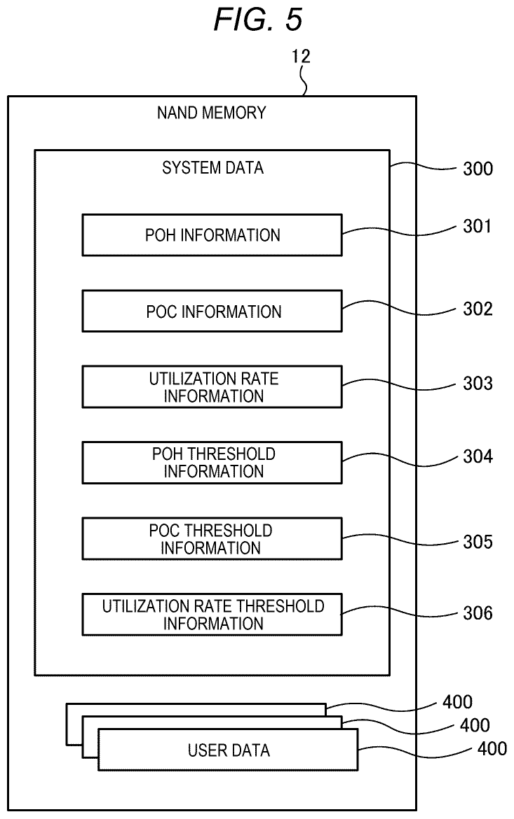

FIG. 5 is a diagram showing an example of data stored in the NAND memory 12 according to the first embodiment.

The NAND memory 12 stores system data 300 and user data 400. The system data 300 is data required for the operation of the memory system 1 and for managing the operation of the memory system 1. The user data 400 is data received from the host 2 and for which writing is requested by a write request from the host 2.

The system data 300 includes POH information 301, POC information 302, utilization rate information 303, POH threshold information 304, POC threshold information 305, and utilization rate threshold information 306.

In a power-on state, the memory controller 11 records the POH, POC, and utilization rate in the DRAM 13, and updates them in real time on the DRAM 13. In response to power-off, the memory controller 11 stores the POH recorded in the DRAM 13 in the NAND memory 12 as the POH information 301. Similarly, in response to power-off, the memory controller 11 stores the POC recorded in the DRAM 13 in the NAND memory 12 as the POC information 302, and stores the utilization rate recorded in the DRAM 13 in the NAND memory 12 as the utilization rate information 303. Next, when the memory system 1 is powered on, the memory controller 11 loads the POH information 301, the POC information 302, and the utilization rate information 303 into the DRAM 13 and starts operations.

The POH threshold information 304 is information in which the POH threshold is recorded. The POC threshold information 305 is information in which POC thresholds are recorded. The utilization rate threshold information 306 is information in which utilization rate thresholds are recorded.

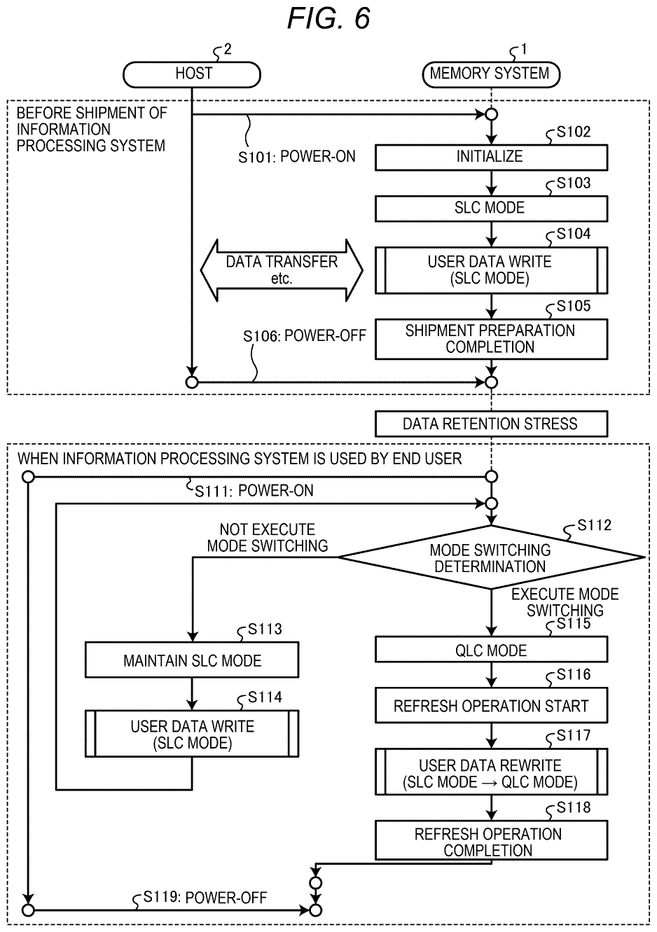

FIG. 6 is a diagram showing an example of the operation of the information processing system 1000 according to the first embodiment.

The operations from step S101 to step S106 are executed before shipment of the information processing system 1000. More specifically, these operations are executed when the manufacturer of the information processing system 1000 incorporates the memory system 1 into the information processing system 1000 and sets up the information processing system 1000 so that an end user can use the information processing system 1000.

When the memory system 1 is powered on by the operation of the host 2 (S101), the memory controller 11 performs an initialization operation (S102). The initialization operation is an operation for performing various settings at the time of initial startup.

The memory controller 11 sets the storage mode to be used when writing to the NAND memory 12, to the SLC mode (S103).

The host 2 transfers various data to the memory system 1. Data transfers include, for example, installation of an operating system and installation of various drivers.

In the memory system 1, the memory controller 11 executes a user data write operation in the SLC mode (S104). The user data write operation is an operation in which data transferred from the host 2 is written to the NAND memory 12 as user data 400. The user data 400 written to the NAND memory 12 in step S104 includes the operating system, various drivers, etc.

When preparation for shipment is completed (S105), the memory system 1 is powered off by the operation of the host 2 (S106), and the information processing system 1000 is shipped.

After shipment, the information processing system 1000 is stored without being powered on until, for example, it is started up by an end user. During that time, the memory system 1 continues to be subjected to data retention stress.

When the information processing system 1000 is started up by the end user, the memory system 1 is powered on by the operation of the host 2 (S111). The memory controller 11 then executes a mode switching determination (S112).

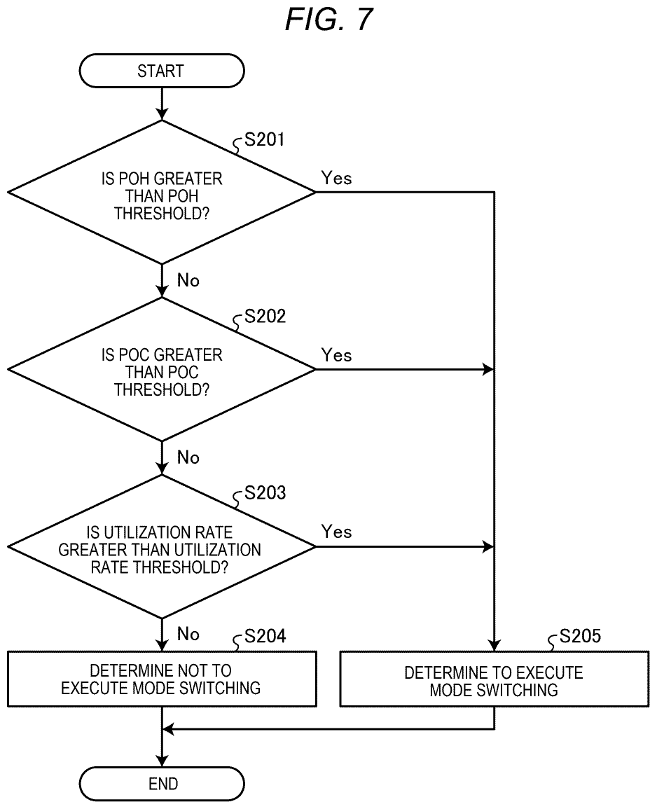

FIG. 7 is a flowchart showing an example of a mode switching determination operation in the first embodiment.

The memory controller 11 determines whether the POH is greater than the POH threshold (S201).

When the POH is not greater than the POH threshold (S201: No), the memory controller 11 determines whether the POC is greater than the POC threshold (S202).

When the POC is not greater than the POC threshold (S202: No), the memory controller 11 determines whether the utilization rate is greater than the utilization rate threshold (S203).

When the utilization rate is not greater than the utilization rate threshold (S203: No), the memory controller 11 determines not to execute mode switching (S204).

When the POH is greater than the POH threshold (S201: Yes), or when the POC is greater than the POC threshold (S202: Yes), or when the utilization rate is greater than the utilization rate threshold (S203: Yes), the memory controller 11 determines to execute mode switching (S205).

After step S204 or step S205, the mode switching determination operation ends.

In the example shown in FIG. 7, when any one of the POH, POC, and utilization rate becomes greater than the threshold, the memory controller 11 determines to execute mode switching. The conditions for mode switching determination are not limited to this.

For example, when all of the POH, POC, and utilization rate become greater than a threshold, the memory controller 11 may determine to execute mode switching, and when any one of the POH, POC, and utilization rate is less than the threshold, the memory controller 11 may determine not to execute mode switching.

In addition, all of the POH, POC, and utilization rate may not be used in the mode switching determination. The memory controller 11 may use only one piece of numerical information or only two pieces of numerical information determined by the designer among the POH, POC, and utilization rate for the mode switching determination. In the case where two pieces of numerical information among the POH, POC, and utilization rate are used for the mode switching determination, the memory controller 11 may determine to execute mode switching when both two pieces of numerical information are greater than a threshold, or the memory controller 11 may determine to execute mode switching when any one of the two pieces of numerical information is greater than a threshold.

In addition, the operation when the POH, POC, or utilization rate is equal to the threshold is not limited to the example shown in FIG. 7. For example, when the POH is equal to the POH threshold, the control may transition to step S205. When the POC is equal to the POC threshold, the control may transition to step S205. When the utilization rate is equal to the utilization rate threshold, control may transition to step S205.

Returning back to FIG. 6, the description will be continued.

When the mode switching determination determines not to execute the mode switching, the memory controller 11 maintains the storage mode in the SLC mode (S113). When a write request is received from the host 2, the memory controller 11 executes a user data write operation in the SLC mode (S114). Then, control transitions to step S112.

When the mode switching determination determines to execute the mode switching, the memory controller 11 sets the storage mode to be used when writing to the NAND memory 12, to the QLC mode (S115). Therefore, after step S115, when a write request is received from the host 2, the memory controller 11 executes a user data write operation in the QLC mode.

Furthermore, the memory controller 11 starts a refresh operation in response to setting the storage mode to be used when writing to the NAND memory 12 to the QLC mode (S116). That is, the memory controller 11 reads the user data 400 written to the NAND memory 12 in the SLC mode, and rewrites the read user data 400 to the NAND memory 12 in the QLC mode (S117). This resets the effects of data retention stored in the user data 400 (see step S104) written to the NAND memory 12 before shipment.

After the refresh operation is completed (S118), the memory controller 11 can execute various operations in response to requests from the host 2. When the memory system 1 is powered off by the operation of the host 2 (S119), the series of operations ends.

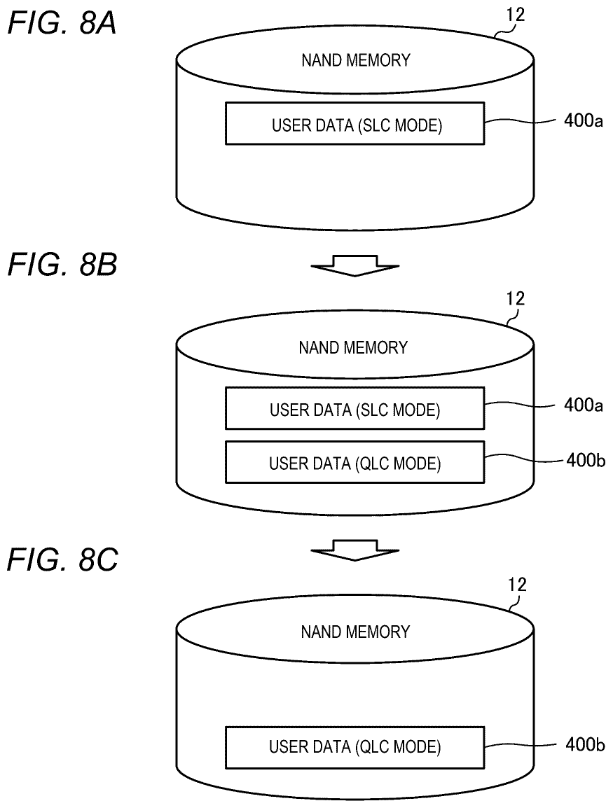

FIG. 8 is a diagram illustrating an example of the transition of the state of the user data 400 stored in the NAND memory 12 according to the first embodiment.

During the period from step S104 to step S115 shown in FIG. 6, as shown in part (A) of FIG. 8, the user data 400 stored in the NAND memory 12 is all user data 400a written in the SLC mode.

After step S115 shown in FIG. 6, the user data 400 is written to the NAND memory 12 in the QLC mode. Furthermore, the user data 400 stored in the NAND memory 12 in the SLC mode is rewritten to the NAND memory 12 in the QLC mode by a refresh operation. Therefore, during the period from step S115 to step S118, as shown in part (B) of FIG. 8, the NAND memory 12 includes a mixture of user data 400a written in the SLC mode and user data 400b written in the QLC mode.

After step S118 shown in FIG. 6, as shown in part (C) of FIG. 8, the user data 400 stored in the NAND memory 12 is all user data 400b written in the QLC mode.

Thus, according to the first embodiment, the NAND memory 12 is configured to be able to perform writing in a storage mode, namely, either a QLC mode (an example of the first mode) or an SLC mode (an example of the second mode having higher reliability than the first mode). The memory controller 11 writes data received from the host 2 to the NAND memory 12 in the SLC mode until the condition related to any one of the POH (an example of a first value), the POC (an example of a second value), and the utilization rate (an example of a third value) is satisfied. After the above conditions are satisfied, the memory controller 11 writes data newly received from the host 2 to the NAND memory 12 in the QLC mode.

Therefore, it is possible to maintain high reliability of data from the time the information processing system 1000 is shipped to the time it is started to be used by the end user. In other words, the memory system 1 can be considered to have high reliability.

According to the first embodiment, the memory controller 11 autonomously switches the storage mode from the SLC mode to the QLC mode in response to the above conditions being satisfied. In other words, a request for mode switching from the host 2 is not required. Therefore, in addition to improving the reliability of data, it is possible to improve convenience for end users and manufacturers of the information processing system 1000.

According to the first embodiment, the memory controller 11 rewrites the data written in the SLC mode to the NAND memory 12 in the QLC mode when the above-mentioned conditions are satisfied.

Therefore, the memory controller 11 can autonomously reset the influence of data retention stored in the data written to the NAND memory 12 before shipment.

In the first embodiment, the QLC mode is given as an example of the first mode, and the SLC mode is given as an example of the second mode. Examples of the first and second modes are not limited to these.

For example, any one of the first mode and the second mode can be selected by the designer as long as the first mode is a mode in which the number of bits of data written per memory cell is a first number, and the second mode is a mode in which the number of bits of data written per memory cell is a second number less than the first number.

Alternatively, the first mode and the second mode may be error correction coding modes with different error correction capabilities. For example, the first mode is a mode in which error correction coding is performed using a first error correction code. The second mode is a mode in which a second error correction code with a higher error correction capability than the first error correction code is performed. Even in such a case, by using the second mode, it is possible to obtain higher reliability than in the first mode.

Further, as described above, according to the first embodiment, the designer can select any of the conditions for determination using the POH, POC, and utilization rate.

For example, the condition may be that any one of the predetermined one or more pieces of numerical information among the POH, POC, and utilization rate exceeds a threshold. Further, the condition may be that all of the predetermined one or more pieces of numerical information among the POH, POC, and utilization rate exceeds a threshold.

### Second Embodiment

In a second embodiment, a memory system executes a refresh operation according to an elapsed time since data was last written before shipment, including the period during which the memory system is stored in a power-off state. This allows the memory controller to appropriately reset the effect of retention received by the data stored in the NAND memory before shipment.

The memory system cannot know the current time using only its own functions. Therefore, the memory system obtains the current time at that timing between when the power is turned on and when the power is turned off from the host as time information. The memory system then calculates the elapsed time since data was last written, based on the obtained time information. As an example, it is assumed here that the memory system obtains the time information from the host at the time of power on.

Hereinafter, the memory system of the second embodiment is referred to as a memory system 1a, and a memory controller in the memory system 1a is referred to as a memory controller 11a. The following description will focus on the differences from the first embodiment.

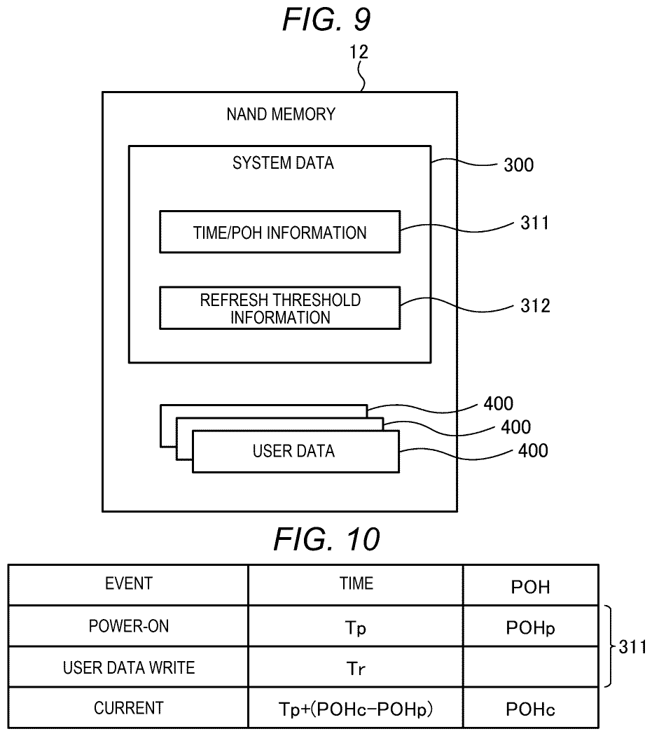

FIG. 9 is a diagram showing an example of data stored in the NAND memory 12 provided in the memory system 1a according to the second embodiment.

The NAND memory 12 stores system data 300 and user data 400. The system data 300 includes time/POH information 311 and refresh threshold information 312.

The time/POH information 311 records a pair of time information received from the host 2 and the POH when the time information is received. Specific examples of the information recorded in the time/POH information 311 will be described later.

The refresh threshold information 312 records a refresh threshold which is a threshold to be compared with the elapsed time since data was last written (or rewritten). The refresh threshold is determined by the designer. The designer can determine the refresh threshold taking into account the period and storage conditions in which the information processing system 1000 is stored after shipment.

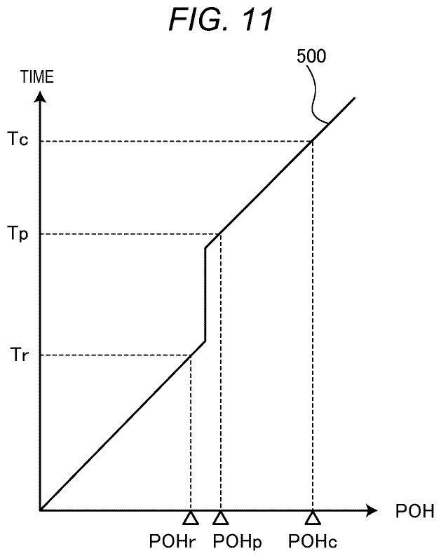

FIG. 10 is a diagram illustrating a specific example of information recorded in the time/POH information 311 in the second embodiment. FIG. 10 shows a pair of time and POH for each event.

The memory controller 11a obtains time information from the host 2 at the time of power on. The time information obtained at the time of power on is referred to as Tp. The memory controller 11a records Tp and the POH monitor value (referred to as POHp) at the time of power on as a pair in the time/POH information 311.

Furthermore, when executing a user data write operation, the memory controller 11a calculates the time (referred to as Tr) at the time of execution of the user data write operation, and records the time Tr obtained by the calculation in the time/POH information 311.

The memory controller 11a can calculate the current time (referred to as Tc) at any timing, based on the POH monitor value (referred to as POHc) by using the following Equation (1).

$$TC = Tp + ( P 0 Hc - P 0 Hp ) \qquad ( 1 )$$

When executing a user data write operation, the memory controller 11a obtains the POH monitor value, and calculates the current time based on the obtained POH monitor value, the pair of time Tp and POHp recorded in the time/POH information 311, and the above Equation (1). The memory controller 11a then records the obtained current time in the time/POH information 311 as the time Tr when the user data write operation is executed.

FIG. 11 is a diagram illustrating a method of calculating an elapsed time since data was last written according to the second embodiment. In FIG. 11, the horizontal axis represents POH, and the vertical axis represents time.

POH increases over time when the power-on state is maintained, and stops increasing in the power-off state. Therefore, POH changes as shown in FIG. 500. It can be seen from FIG. 500 that the current time Tc is obtained by adding the increment of POH from POHp to POHc to the time Tp at the time of power on (that is, obtained by Equation (1)).

The memory controller 11a calculates the elapsed time since data was last written by subtracting Tr from the current time Tc. In other words, the memory controller 11a calculates the elapsed time Te using the following Equation (2).

$$Te = Tp + ( P 0 Hc - P 0 Hp ) - Tr \qquad ( 2 )$$

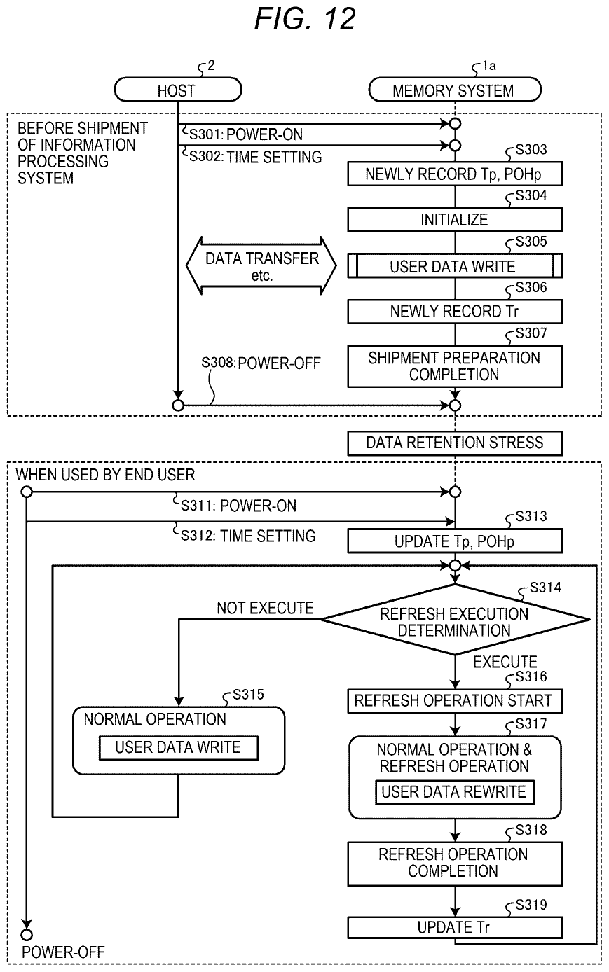

FIG. 12 is a diagram showing an example of the operation of the information processing system 1000 according to the second embodiment.

The operations from step S301 to step S308 are executed before shipping of the information processing system 1000.

First, the memory system 1a is powered on by the operation of the host 2 (S301). The host 2 sets the time for the memory system 1a (S302).

In step S302, the host 2 transfers time information indicating the current time to the memory system 1a. For example, when the communication interface between the host 2 and the memory system 1a complies with NVM express (NVMe™), the host 2 can set a timestamp indicating the current time, for the memory system 1a. In such a case, in step S302, the host 2 transfers the time information using a function of setting a timestamp. The method of setting the time is not limited to this. The host 2 can set the time using any method. For example, the memory controller 11a may be configured to request the host 2 to set the time in response to power-on, and the host 2 may be configured to set the time in response to the request from the memory controller 11a.

The memory controller 11a newly records the time Tp indicated by the time information received from the host 2 and POHp, which is the POH monitor value at that time in a pair in the time/POH information 311 (S303).

Next, the memory controller 11a performs an initialization operation (S304).

Furthermore, the host 2 transfers various data to the memory system 1a. Data transfers include, for example, installation of an operating system and installation of various drivers. In the memory system 1a, the memory controller 11a executes a user data write operation of writing the data transferred from the host 2 to the NAND memory 12 as user data 400 (S305).

When executing the user data write operation, the memory controller 11a calculates the time Tr at that time based on Equation (1), and newly records the time Tr obtained by the calculation in the time/POH information 311 (S306).

When preparation for shipment is completed (S307), the memory system 1a is powered off by the operation of the host 2 (S308), and the information processing system 1000 is shipped.

After shipment, the information processing system 1000 is stored in a power-off state until it is started up by, for example, an end user. During that time, the data stored in the NAND memory 12 (see step S305) continues to be subjected to data retention stress.

When the information processing system 1000 is started up by an end user, the memory system 1a is powered on by the operation of the host 2 (S311). The host 2 sets the time for the memory system 1a (S312). The memory controller 11a records the time Tp indicated by the time information received from the host 2 and POHp, which is the POH monitor value at that time in a pair in the time/POH information 311 (S313). In step S313, the memory controller 11a overwrites (that is, updates) the pair already recorded in step S303 with the newly obtained pair.

Next, the memory controller 11a executes a refresh execution determination (S314).

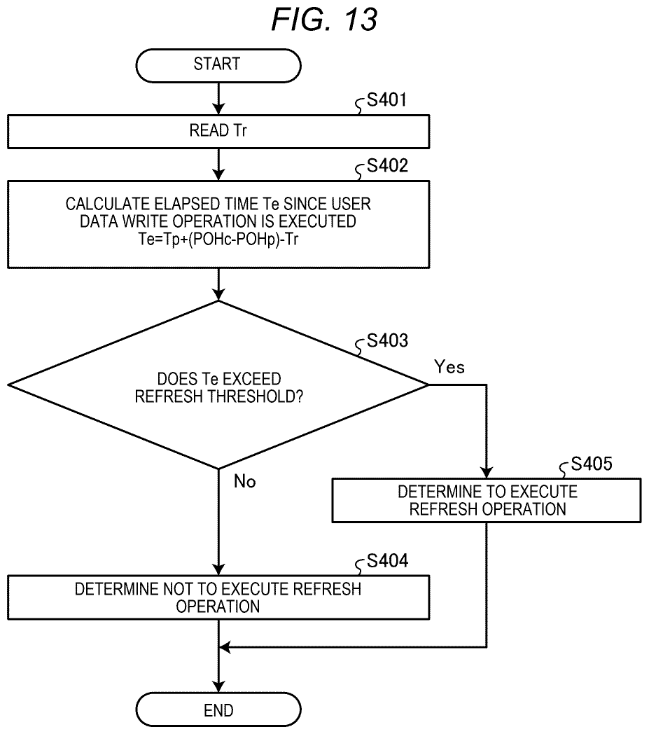

FIG. 13 is a flowchart showing an example of a refresh execution determination operation according to the second embodiment.

The memory controller 11a reads the time Tr from the time/POH information 311 (S401). Then, the memory controller 11a calculates the elapsed time Te since the user data write operation is executed, using Equation (2) (S402).

The memory controller 11a determines whether Te exceeds the refresh threshold (S403).

When Te does not exceed the refresh threshold (S403: No), the memory controller 11a determine not to execute a refresh operation (S404).

When Te exceeds the refresh threshold (S403: Yes), the memory controller 11a determines to execute a refresh operation (S405).

After step S404 or step S405, the refresh execution determination operation ends.

In the example shown in FIG. 13, when Te is equal to the refresh threshold, control transitions to S404. When Te is equal to the refresh threshold, control may transition to S405.

Returning back to FIG. 12, the description will be continued.

When the refresh execution determination determines not to execute the refresh operation, the memory controller 11a executes a normal operation (S315). That is, the memory controller 11a executes an operation in response to a request from the host 2. When a write request is received from the host 2 during the normal operation, the memory controller 11a executes a user data write operation. Then, control transitions to step S314.

When the refresh execution determination determines to execute the refresh operation, the memory controller 11a starts the refresh operation (S316). After step S316, the memory controller 11a executes the refresh operation while executing the normal operation (S317). That is, when a write request is received from the host 2, the memory controller 11a executes a user data write operation. In addition, the memory controller 11a reads the user data 400 (see step S305) written to the NAND memory 12 before shipment, and rewrites the read user data 400 to the NAND memory 12. This resets the effects of data retention stored in the user data 400 written to the NAND memory 12 before shipment.

When the refresh operation is completed (S318), the memory controller 11a calculates the current time using Equation (1) and updates the time Tr recorded in the time/POH information 311 with the current time obtained by the calculation (S319). Then, control transitions to step S314. When control transitions again to step S316 after passing through step S319, the user data 400 that is rewritten in the previous process of step S317 is further rewritten.

Thus, according to the second embodiment, the memory controller 11a obtains the time Tp (an example of the first time) from the host 2 at the timing of step S301 (an example of the first timing) when the memory system 1a is powered on. The memory controller 11a writes, to the NAND memory 12, the user data 400 (an example of the first data) received from the host 2 during the period from the first timing to the timing of step S308 (an example of the second timing) when the memory system 1a is powered off. Then, the memory controller 11a calculates the time Tr (an example of the second time) of writing the user data 400 based on the time Tp obtained from the host 2, and records the time Tr obtained by the calculation. After that, at the timing of step S311 (an example of the third timing) when the memory system 1a is powered on, the memory controller 11a newly obtains the time Tp (an example of the third time) from the host 2. Then, the memory controller 11a calculates the elapsed time Te from the time Tr, based on the time Tr and the newly obtained time Tp. Based on the elapsed time Te, the memory controller 11a rewrites the data (that is, the first data) received from the host 2 and written to the NAND memory 12 before the timing of step S308.

Therefore, it is possible to execute a refresh operation based on the elapsed time including the period during which the information processing system 1000 is stored in a power-off state. This makes it possible to appropriately reset the effects of data retention on the data stored in the NAND memory 12 before shipment, and to prevent the reliability of the data from being compromised. In other words, the memory system 1a can be considered to have high reliability.

Furthermore, according to the second embodiment, the memory controller 11a further records the time Tp in a pair with POHp (an example of a first value), which is a POH monitor value, at the timing of step S301 when the memory system 1a is powered on (an example of a first timing). Then, the memory controller 11a calculates the time Tr, based on the POH monitor value when the first data is written to the NAND memory 12 and the pair of Tp and POHp.

Therefore, the memory controller 11a can obtain the time Tp by calculation based on the time information obtained from the host 2.

The timing at which the memory controller 11a obtains the time information from the host 2 is not limited to the timing at which the power is turned on. The memory controller 11a may obtain the time information at any timing between when the power is turned on and when the power is turned off. The memory controller 11a can obtain the time at any timing by calculation as long as it is within the period between when the time information is obtained and when the power is turned off.

Furthermore, according to the second embodiment, at the timing of step S311 when the memory system 1a is powered on (an example of a third timing), the memory system 1a records the time Tp in a pair with POCp, which is the POC monitor value at that timing. Then, in step S314, the memory controller 11a calculates the elapsed time Te, based on the POC monitor value at the timing of step S314 (an example of the fourth timing), the time Tr, and the pair of Tp and POHp recorded at the third timing.

Thus, the memory controller 11a can calculate the elapsed time including the period during which the information processing system 1000 is stored in a power-off state.

### Third Embodiment

In the second embodiment, when the information processing system is powered on after shipment, the memory controller executes a refresh operation according to an elapsed time since data was last written, including the period during which the information processing system is stored without being powered on. In the third embodiment, a memory system is configured to be able to execute a refresh operation without the need for powering on by the operation of the host.

Hereinafter, the memory system of the third embodiment will be referred to as a memory system 1b, and a memory controller in the memory system 1b will be referred to as a memory controller 11b. The following description will focus on the differences from the first and second embodiments.

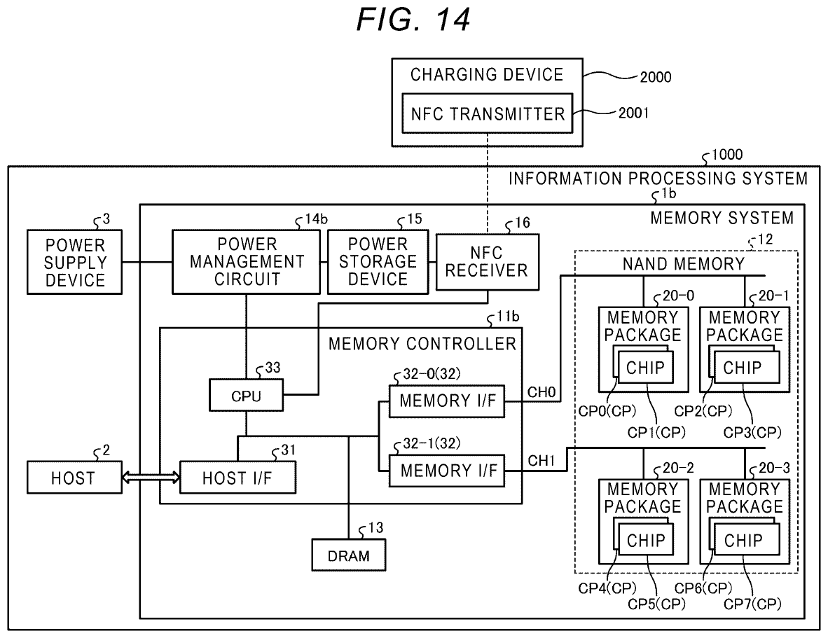

FIG. 14 is a diagram showing an example of a configuration of the memory system according to the third embodiment. As shown in FIG. 14, the memory system 1b is incorporated into the information processing system 1000.

The memory system 1b includes the memory controller 11b, a NAND memory 12, a DRAM 13, a power management circuit 14b, a power storage device 15, and a Near Field Communication (NFC) receiver 16.

The NFC receiver 16 is a receiving device capable of receiving electrical energy and data contactlessly. When a charging device 2000 equipped with an NFC transmitter 2001 is installed and the distance between the NFC transmitter 2001 and the NFC receiver 16 is shorter than the distance over which electrical energy and data can be transferred, the NFC receiver 16 can receive the electrical energy and the data contactlessly from the NFC transmitter 2001. When the NFC receiver 16 receives electrical energy from the NFC transmitter 2001, the NFC receiver 16 transmits the electrical energy to the power storage device 15.

The power storage device 15 stores the electrical energy transmitted from the NFC receiver 16. The power storage device 15 may be a chargeable and dischargeable battery or a capacitor.

The power management circuit 14b is configured to generate power for driving the memory controller 11b, the NAND memory 12, and the DRAM 13 based on the power stored in the power storage device 15, in addition to the functions of the power management circuit 14 according to the first embodiment.

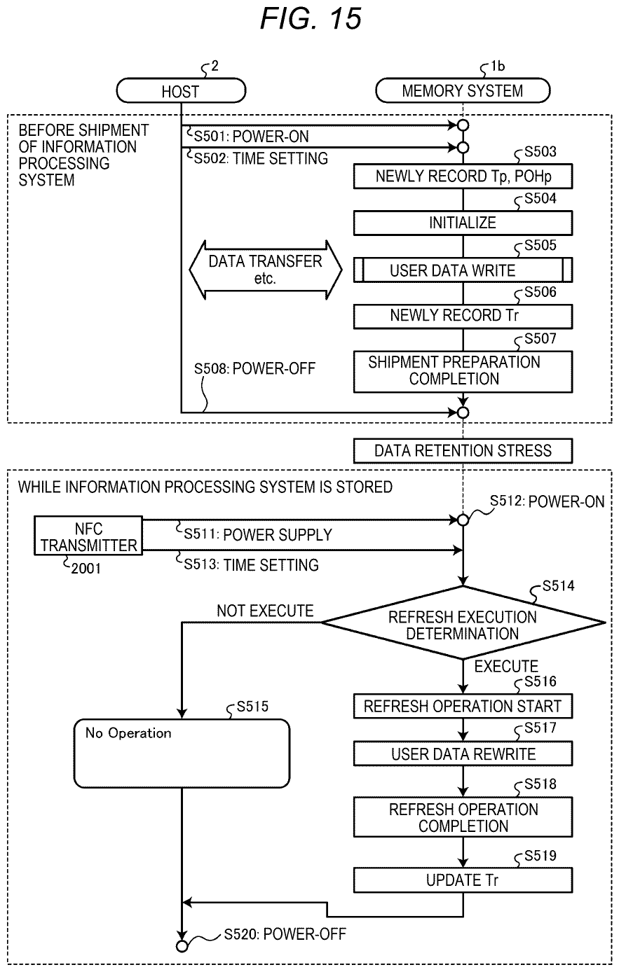

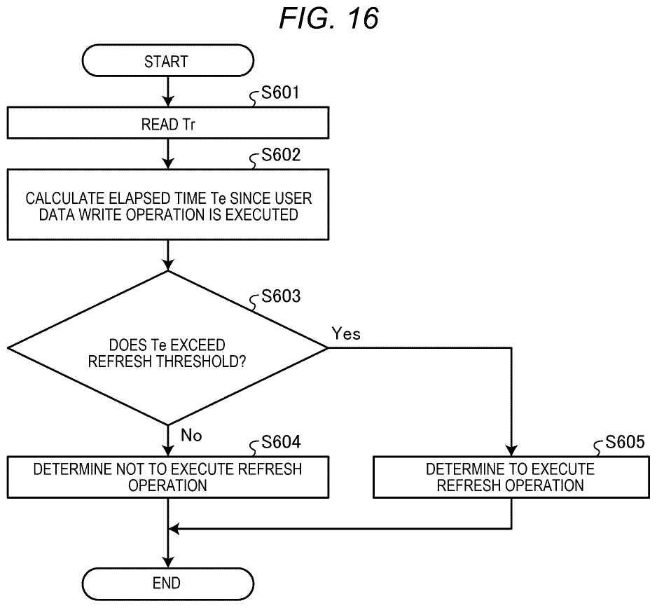

FIG. 15 is a diagram showing an example of the operation of the information processing system 1000 according to the third embodiment.

The operations from step S501 to step S508 are executed before shipment of the information processing system 1000. The operations from step S501 to step S508 are the same as the operations from step S301 to step S308 in the second embodiment described using FIG. 12, and therefore will not be described here.

After shipment, the information processing system 1000 is stored in a power-off state. Until the memory system 1b is powered on, the data stored in the NAND memory 12 (see step S505) continues to be subjected to data retention stress.

When the charging device 2000 is brought close to the memory system 1b while the information processing system 1000 is stored, the NFC receiver 16 receives a supply of electrical energy transmitted from the NFC transmitter 2001 (S511), and the power storage device 15 stores the electrical energy.

Then, at a predetermined timing, for example, when sufficient electrical energy to drive the memory system 1b is accumulated in the power storage device 15, the memory controller 11b autonomously powers on the memory system 1b using the electrical energy stored in the power storage device 15 (S512). The power management circuit 14b generates power to drive the memory controller 11b using the electrical energy stored in the power storage device 15, and the memory controller 11b is driven by that power to power on the memory system 1b.

After the memory system 1b is powered on, the NFC transmitter 2001 sets the time for the memory system 1b (S513). In step S513, the memory controller 11b obtains the current time at that time from the NFC transmitter 2001 as the power-on time Tp.

Next, the memory controller 11b executes a refresh execution determination (S514).

FIG. 16 is a flowchart showing an example of a refresh execution determination operation according to the third embodiment.

The memory controller 11b reads the time Tr from the time/POH information 311 (S601). Then, the memory controller 11b calculates the elapsed time Te since the user data write operation is executed, using the following Equation (3) (S602).

$$Te = Tp - Tr \qquad ( 3 )$$

The memory controller 11b determines whether Te exceeds the refresh threshold (S603).

When Te does not exceed the refresh threshold (S603: No), the memory controller 11b determines not to execute a refresh operation (S604).

When Te exceeds the refresh threshold (S603: Yes), the memory controller 11b determines to execute a refresh operation (S605).

After step S604 or step S605, the refresh execution determination operation ends.

In the example shown in FIG. 16, when Te is equal to the refresh threshold, control transitions to S604. When Te is equal to the refresh threshold, control may transition to S605.

Returning back to FIG. 15, the description will be continued.

When the refresh execution determination determines not to execute the refresh operation, the memory controller 11b does not execute any operation (S515) and autonomously powers off the memory system 1b (S520).

When the refresh execution determination determines to execute the refresh operation, the memory controller 11b starts the refresh operation (S516). In the refresh operation, the memory controller 11b reads the user data 400 (see step S505) that is written to the NAND memory 12 before shipment, and rewrites the read user data 400 to the NAND memory 12 (S517). This resets the effects of data retention stored in the user data 400 written to the NAND memory 12 before shipment.

When the refresh operation is completed (S518), the memory controller 11b updates the time Tp obtained by the process of step S513 with the time Tr recorded in the time/POH information 311 as the new time Tr (S519). Then, the memory controller 11b autonomously powers off the memory system 1b (S520).

In the third embodiment, in step S519, the time Tp when the memory system 11b is autonomously powered on is recorded as the time Tr of the user data write operation (more precisely, the user data rewrite operation). The memory controller 11b records the time Tp when the memory system 11b is autonomously powered on in the time/POH information 311 in a pair with the POH monitor value POHp at that time, and in step S519, may calculate the time Tr using Equation (1) as in the memory controller 11a according to the second embodiment.

Furthermore, the number of times that the operations of steps S511 to S520 are executed is not limited to one. While the information processing system 1000 is stored, the operations of steps S511 to S520 may be executed a plurality of times.

Thus, according to the third embodiment, the memory controller 11b is configured to be able to autonomously power on the memory system 1b using electrical energy received by the NFC receiver 16.

Then, the memory controller 11b newly obtains a time Tp (an example of a third time) at the timing (an example of a third timing) when the memory system 1b is autonomously powered on. The memory controller 11b calculates the elapsed time from the time Tr to the newly obtained time Tp. When the elapsed time exceeds the refresh threshold, the memory controller 11b autonomously powers off the memory system 1b by rewriting the user data 400 (see step S505) written to the NAND memory 12 before shipment. When the elapsed time does not satisfy the refresh threshold, the memory controller 11b autonomously powers off the memory system 1b without rewriting the user data 400 (see step S505) written to the NAND memory 12 before shipment.

Thus, even while the information processing system 1000 is stored after shipment of the information processing system 1000, the memory controller 11b can appropriately execute a refresh operation by the electrical energy received contactlessly. This makes it possible to appropriately reset the effects of data retention on the data stored in the NAND memory 12 before shipment, and to prevent the reliability of the data from being compromised. In other words, the memory system 1b can be considered to have high reliability.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system connectable to a host, the memory system comprising:
a nonvolatile memory configured to perform writing in either a first mode or a second mode; and
a memory controller configured to:
write first data, received from the host, to the nonvolatile memory in the second mode until a condition related to any one of a first value, a second value, or a third value is satisfied, the first value being a total value of time during which a power-on state is maintained, the second value being the number of times a power has been turned on, and the third value being the number of program/erase cycles executed on the nonvolatile memory; and
after the condition is satisfied, write second data, received from the host, to the nonvolatile memory in the first mode.

2. The memory system according to claim 1, wherein
the memory controller is further configured to rewrite the first data to the nonvolatile memory in the first mode when the condition is satisfied.

3. The memory system according to claim 1, wherein
the nonvolatile memory includes a plurality of memory cells,
the first mode corresponds to the number of bits of data written per memory cell being a first number, and
the second mode corresponds to the number of bits of data written per memory cell being a second number less than the first number.

4. The memory system according to claim 3, wherein
the first number is four.

5. The memory system according to claim 4, wherein
the second number is one.

6. The memory system according to claim 1, wherein
the condition corresponds to one or more of the first value, the second value, or the third value exceeds a threshold.

7. The memory system according to claim 1, wherein
the condition corresponds to all predetermined values of the first value, the second value, and the third value exceed a threshold.

8. The memory system according to claim 1, wherein
data written in the second mode has higher reliability than data written in the first mode data.

9. The memory system according to claim 1, wherein
a power of the memory system is supplied from an external device.

10. The memory system according to claim 1, wherein
the nonvolatile memory is a NAND flash memory.

11. A memory system connectable to a host, the memory system comprising:
a nonvolatile memory; and
a memory controller configured to:
obtain a first time from the host between a first timing when the power is turned on and a second timing when the power is turned off;
write first data, received from the host, to the nonvolatile memory between the first timing and the second timing;
calculate a second time to write the first data based on the first time, and record the second time;
obtain a third time at a third timing when the power is turned on after the second timing;
calculate an elapsed time from the second time based on the second time and the third time; and
rewrite the first data to the nonvolatile memory based on the elapsed time.

12. The memory system according to claim 11, wherein
the memory controller is further configured to:
monitor power-on time, which is a total value of time during which the power-on state is maintained;
record the first time in a pair with a first value, which is a monitor value of the power-on time when the first time is obtained, and
calculate the second time, based on a second value, which is a monitor value of the power-on time when the first data is written, and a pair of the first time and the first value.

13. The memory system according to claim 12, wherein
the memory controller is further configured to:
record the third time in a pair with a third value, which is a monitor value of the power-on time when the third time is obtained, and
at a fourth timing after the third timing, calculate an elapsed time from the second time to the fourth timing, based on the second time, a pair of the third time and the third value, and a monitor value of the power-on time at the fourth timing.

14. The memory system according to claim 11, further comprising:
a receiving device configured to receive electrical energy and data without contact, wherein
the memory controller is further configured to power on the memory system using the electrical energy received by the receiving device.

15. The memory system according to claim 14, wherein
the third timing is a timing at which the memory controller powers on the memory system using the electrical energy received by the receiving device.

16. The memory system according to claim 15, wherein
the memory controller is further configured to:
calculate an elapsed time from the second time to the third time; and
when the elapsed time exceeds a threshold, rewrite the first data to the nonvolatile memory and power off the memory system.

17. The memory system according to claim 15, wherein
the memory controller is further configured to:
calculate an elapsed time from the second time to the third time; and
when the elapsed time does not satisfy the threshold, not rewrite the first data to the nonvolatile memory, and power off the memory system.

18. The memory system according to claim 11, wherein
the nonvolatile memory is a NAND flash memory.
